(19) United States
(12) Patent Application Publication
(10) Pub. No.: US 2019/0369527 A1
(43) Pub. Date: Dec. 5, 2019

(54) INTERMEDIATE TRANSFER BELT AND IMAGE-FORMING APPARATUS

(71) Applicant: Konica Minolta, Inc., Tokyo (JP)

(72) Inventors: Eiichi YOSHIDA, Tokyo (JP); Shinichi Hamaguchi, Tokyo (JP); Ito Koga, Tokyo (JP); Shiori Tsugawa, Tokyo (JP); Akira Ohira, Tokyo (JP)

(21) Appl. No.: 16/402,983

(22) Filed: May 3, 2019

(30) Foreign Application Priority Data
Jun. 5, 2018 (JP) 2018-107332

(51) Int. Cl. G03G 15/16

(52) U.S. Cl. CPC G03G 15/162

(57) ABSTRACT

Provided is an intermediate transfer belt for use in an electrophotographic image-forming apparatus, the intermediate transfer belt containing a polyamide-imide, a conductive agent, and a dispersant, the dispersant having a block polymer structure.

### BACKGROUND

### 1. Technological Field

The present invention relates to an intermediate transfer belt and an image-forming apparatus, and more particularly relates to an intermediate transfer belt with superior durability and an image-forming apparatus including the intermediate transfer belt.

### 2. Description of the Related Art

An electrophotographic image-forming apparatus employing an intermediate transfer belt is conventionally known, in which a toner image formed on a photoconductor is primarily transferred to the intermediate transfer belt and then the toner image on the intermediate transfer belt is secondarily transferred to a transfer material such as transfer paper (recording paper). Specifically, the toner image formed on the photoconductor and charged with a certain polarity is transferred to the intermediate transfer belt by means of electrostatic force, and subsequently the toner image on the intermediate transfer belt is transferred to the transfer material by means of electrostatic force.

With such an image-forming apparatus employing an intermediate transfer belt, toner images formed on different photoconductors can be sequentially superimposed on the intermediate transfer belt by means of electrostatic force, and the superimposed toner images can be collectively transferred to the transfer material. Such an image-forming apparatus is therefore widely used as a color image-forming apparatus.

In general, intermediate transfer belts are made mainly of a polyimide or polyamide-imide, which is superior in mechanical properties, electrical insulation properties, and heat resistance, and further contain carbon black dispersed as a conductive filler in the polyimide or polyamide-imide for the purpose of adjustment of electrical resistance.

Polyamide-imides have higher solubility in solvents than polyimides and can be baked at low temperature, thus offering great benefits in terms of production. However, polyamide-imides have lower mechanical strength and voltage endurance than polyimides, and thus polyamide-imide-based intermediate transfer belt have a problem in that repeated use causes a resistance change or a strength decrease which may lead to breakage.

As a result of attempts to increase the strength of polyamide-imide-based intermediate transfer belts, intermediate transfer belts have been disclosed which have an improved wear resistance due to incorporation of a phosphoric acid ester or polybenzimidazole into a polyamide-imide (see Japanese Patent Laid-Open No. 2012-48234 and Japanese Patent Laid-Open No. 2012-150472).

However, even these intermediate transfer belts cannot exhibit satisfactory improvement in durability, and there has been a demand for a polyamide-imide-based intermediate transfer belt that undergoes little resistance change or strength decrease even when repeatedly used.

### SUMMARY

It is an object of the present invention to provide an polyamide-imide-based intermediate transfer belt with superior durability. It is also an object of the present invention to provide an image-forming apparatus including the intermediate transfer belt.

To achieve the abovementioned objects, an intermediate transfer belt according to an aspect of the present invention is an intermediate transfer belt for use in an electrophotographic image-forming apparatus, the intermediate transfer belt comprising a polyamide-imide, a conductive agent, and a dispersant, the dispersant having a block polymer structure.

### BRIEF DESCRIPTION OF THE DRAWINGS

The objects, effects, and features of the present invention will become more fully understood from the detailed description given hereinbelow and the appended drawing, which are not intended to define the limits of the present invention.

FIG. 1 is a cross-sectional configuration diagram showing an example of an image-forming apparatus in which an intermediate transfer belt of the present invention can be used.

### DETAILED DESCRIPTION OF EMBODIMENTS

Hereinafter, one or more embodiments of the present invention will be described with reference to the drawings. However, the scope of the invention is not limited to the disclosed embodiments.

An intermediate transfer belt of the present invention is an intermediate transfer belt for use in an electrophotographic image-forming apparatus, the intermediate transfer comprising a polyamide-imide, a conductive agent, and a dispersant, the dispersant having a block polymer structure. These features are technical features common to the embodiments described below.

Thanks to the features of the present invention, a polyamide-imide-based intermediate transfer belt with superior durability can be provided. An image-forming apparatus including the intermediate transfer belt can also be provided.

Although the mechanism of expression or action has not been clarified for the effect of the present invention, the following hypothesis can be formulated.

Even though a polyamide-imide is used, the use of a dispersant having a block polymer structure can provide durability comparable to that achieved when a polyimide is used. This mechanism of expression is considered due to the functional separation between a segment with affinity for the conductive agent and a segment with affinity for the solvent and resin in the block polymer. For conventional cases where the dispersant is a polymer of the random copolymerization type, it is thought that both adsorption of the dispersant onto the conductive agent and dissolution of the dispersant in the solvent and resin are insufficient because of no separation between the segment with affinity for the conductive agent and the segment with affinity for the solvent and resin.

The use of a dispersant having a block polymer structure and the corresponding functional separation allow sufficient adsorption of the dispersant onto the conductive agent and prevention of aggregation of the particles of the conductive agent, thus ensuring the dispersion stability of the conductive agent. Additionally, it is thought that, since the same molecules adsorbed on the conductive agent have a segment with affinity for the resin, the conductive agent and the resin become homogenized, and thus the voltage applied to the transfer belt can be uniform and can be converted to a transfer potential without being converted to thermal energy. It is inferred that this effect is demonstrated by a decreased dielectric tangent, which specifically is 1.5 or less at 10 kHz in a 23° C. environment. When the dielectric tangent is 1.5 or less, the efficiency of conversion to transfer potential is high, and secondary transfer can be achieved with a low voltage. This is thought to result in lowering of load on the transfer belt and prevention of resistance change or mechanical strength decrease of the transfer belt.

In an embodiment of the present invention, it is preferable that the dielectric tangent be in the range of 0.2 to 1.5 at 10 kHz in a 23° C. environment from the viewpoint of achieving the effect of the present invention.

It is also preferable that the dispersant have a block polymer structure containing a segment derived from a basic (meth)acrylate and a segment derived from a neutral (meth)acrylate, because in this case the dispersion stability of the conductive agent can be increased.

It is also preferable that the conductive agent be acidic in order to increase the affinity for the segment derived from the basic (meth)acrylate in the dispersant so that the conductive agent can be stably dispersed.

Further, in the present invention, it is preferable that the dispersant in the range of 1 to 20 parts by mass be comprised relative to 100 parts by mass of the conductive agent. This is preferred in order to control the electrical resistance value (volume resistivity) of the intermediate transfer belt within a preferred range.

It is also preferable that the conductive agent have an average particle size in the range of 0.05 to 0.20 μm in order to achieve stable dispersion of the conductive agent.

The intermediate transfer belt of the present invention is suitable for inclusion in an image-forming apparatus.

Hereinafter, the present invention, its elements, and embodiments and modes of the present invention will be described in detail. In the present disclosure, the word “to” as used to specify a numerical range is intended to mean that the range includes the value before “to” as the lower limit and the value after “to” as the upper limit.

In the present invention, the term “(meth)acrylate” refers to “at least one of acrylate and methacrylate”, and the term “(meth)acryl” refers to “at least one of acryl and methacryl”. For example, the term “(meth)acrylic acid” refers to “at least one of acrylic acid and methacrylic acid”.

<<Summary of Intermediate Transfer Belt>>

An intermediate transfer belt of the present invention is an intermediate transfer belt for use in an electrophotographic image-forming apparatus, the intermediate transfer belt comprising a polyamide-imide, a conductive agent, and a dispersant, the dispersant having a block polymer structure.

In the intermediate transfer belt of the present invention, the use of a dispersant having a block polymer structure and the corresponding functional separation ensure dispersion stability. Additionally, since the same molecules adsorbed on the conductive agent have a segment with affinity for the resin, the conductive agent and the resin become homogenized, and thus the voltage applied to the transfer belt can be uniform and can be efficiently converted to a transfer potential. It is inferred that this effect is demonstrated by a decreased dielectric tangent, which specifically is 1.5 or less at 10 kHz in a 23° C. environment. Secondary transfer can thus be achieved with a low voltage, and this is thought to result in lowering of load on the transfer belt and prevention of resistance change or mechanical strength decrease of the transfer belt. A lower dielectric tangent is preferred, because a decrease in dielectric tangent means improvement in uniformity of dispersion. The lower limit of the dielectric tangent is 0.2.

The dielectric tangent can be measured as follows.

Both surfaces of a sample are sputtered with silver, and then the sample is cut into a 10-mm-diameter piece, which is used as a measurement sample. The value of the dielectric tangent can be calculated from a capacitance value at 10 kHz in a 23° C. environment using System 1296/1260 manufactured by Solartron Analytical.

It is preferable that the electrical resistance value (volume resistivity) of the intermediate transfer belt be in the range of 10⁵ to 10¹¹ Ω·cm.

The thickness of the intermediate transfer belt can be chosen as appropriate depending on the intended use. In general, in order to meet requirements as to mechanical properties such as strength and flexibility, it is preferable that the thickness be in the range of 50 to 500 μm, more preferably 200 to 400 μm.

As for the form of the intermediate transfer belt, an endless intermediate transfer belt is preferred because of various advantages such as the following: no superimposition-induced thickness change occurs; and any portion can be used as a starting point of belt rotation, so that any mechanism for control of the rotation starting point is not required.

The intermediate transfer belt of the present invention may consist of a substrate, or, if necessary, other layers such as an elastic layer and a surface layer may be provided on the substrate.

<<Substrate>>

The substrate according to the present invention contains a polyamide-imide, a conductive agent, and a dispersant, the dispersant having a block polymer structure.

It is preferable that the substrate have an electrical resistance value (volume resistivity) in the range of 10⁵ to 10¹¹ Ω·cm. In order to control the electrical resistance value of the substrate within the specified range, the substrate contains a conductive agent. It is preferable that the conductive agent be acidic. It is also preferable that the thickness of the substrate be in the range of 50 to 500 μm, more preferably 200 to 400 μm. Known additives may be added to the substrate.

[Polyamide-Imide]

Polyamide-imides are resins having in the molecular skeleton an imide group which is rigid and an amide group which imparts flexibility. The polyamide-imide used in the present invention can be a polyamide-imide having a commonly known structure.

Commonly known methods for synthesis of polyamide-imide resins include (a) an acid chloride method in which a halide of a tricarboxylic acid derivative having an acid anhydride group, most typically a chloride compound of this derivative, and a diamine are reacted in a solvent to produce a polyamide-imide resin (see Japanese Patent Publication No. 42-15637, for example). Another known method is (b) an isocyanate method in which a tricarboxylic acid derivative containing an acid anhydride group and an aromatic isocyanate are reacted in a solvent to produce a polyamide-imide resin (see Japanese Patent Publication No. 44-19274). Either of these methods can be used. These production methods will be described hereinafter.

(a) Acid Chloride Method

As the halide of a tricarboxylic acid derivative having an acid anhydride group, there can be used, for example, a compound having a structure represented by the following formula (1) or (2).

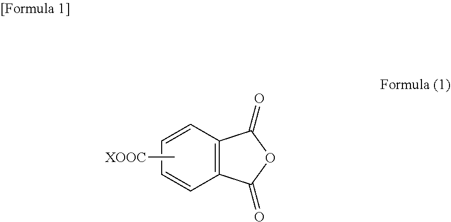

In this formula, X represents a halogen element.

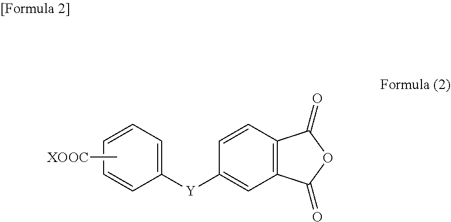

In this formula, X represents a halogen element, and Y represents —CH₂—, —CO—, —SO₂—, or —O—.

In the above formulae, the halogen element is preferably chlorine, and specific examples of the derivative include acid chlorides of polyvalent carboxylic acids such as terephthalic acid, isophthalic acid, 4,4′-biphenyldicarboxylic acid, 4,4′-biphenyletherdicarboxylic acid, 4,4′-biphenylsulfonedicarboxylic acid, 4,4′-benzophenonedicarboxylic acid, pyromellitic acid, trimellitic acid, 3,3′,4,4′-benzophenonetetracarboxylic acid, 3,3′,4,4′-biphenylsulfonetetracarboxylic acid, and 3,3′,4,4′-biphenyltetracarboxylic acid.

These compounds may be used alone or in combination. If necessary, an acid chloride of any of polyvalent carboxylic acids such as adipic acid, sebacic acid, maleic acid, fumaric acid, dimer acid, stilbenedicarboxylic acid, 1,4-cyclohexanedicarboxylic acid, and 1,2-cyclohexanedicarboxylic acid can be used in addition to the above compounds.

The diamine is not particularly limited, and any of aromatic diamines, aliphatic diamines, and alicyclic diamines can be used. An aromatic diamine is preferably used.

Examples of the aromatic diamine include m-phenylenediamine, p-phenylenediamine, oxydianiline, methylenediamine, hexafluoroisopropylidene diamine, diamino-m-xylylene, diamino-p-xylylene, 1,4-naphthalenediamine, 1,5-naphthalenediamine, 2,6-naphthalenediamine, 2,7-naphthalenediamine, 2,2′-bis-(4-aminophenyl)propane, 2,2′-bis-(4-aminophenyl)hexafluoropropane, 4,4′-diaminodiphenyl sulfone, 4,4′-diaminodiphenyl ether, 3,3′-diaminodiphenyl sulfone, 3,3′-diaminodiphenyl ether, 3,4-diaminobiphenyl, 4,4′-diaminobenzophenone, 3,4-diaminodiphenyl ether, isopropylidenedianiline, 3,3′-diaminobenzophenone, o-tolidine, 2,4-tolylenediamine, 1,3-bis-(3-aminophenoxy)benzene, 1,4-bis-(4-aminophenoxy)benzene, 1,3-bis-(4-aminophenoxy)benzene, 2,2-bis-[4-(4-aminophenoxy)phenyl]propane, bis-[4-(4-aminophenoxy)phenyl]sulfone, bis-[4-(3-aminophenoxy)phenyl]sulfone, 4,4′-bis-(4-aminophenoxy)biphenyl, 2,2′-bis-[4-(4-aminophenoxy)phenyl]hexafluoropropane, 4,4′-diaminodiphenylsulfide, and 3,3′-diaminodiphenylsulfide.

A siloxane compound having amino groups at both terminals, such as 1,3-bis(3-aminopropyl)-1,1,3,3-tetramethyldisiloxane, α,ω-bis(3-aminopropyl)polydimethylsiloxane, 1,3-bis(3-aminophenoxymethyl)-1,1,3,3-tetramethyldisiloxane, α,ω-bis(3-aminophenoxymethyl)polydimethylsiloxane, 1,3-bis(2-(3-aminophenoxy)ethyl)-1,1,3,3-tetramethyldisiloxane, α,ω-bis(2-(3-aminophenoxy)ethyl)polydimethylsiloxane, 1,3-bis(3-(3-aminophenoxy)propyl)-1,1,3,3-tetramethyldisiloxane, or α,ω-bis(3-(3-aminophenoxy)propyl)polydimethylsiloxane, may also be used as the diamine, and in this case a silicone-modified polyamide-imide can be obtained.

To obtain a polyamide-imide (polyamide-imide resin) according to the present invention by the acid chloride method, the above-described halide of a tricarboxylic acid derivative having an acid anhydride group and the above-described diamine may be dissolved in an organic polar solvent and then reacted at low temperature (0 to 30° C.). This reaction gives a polyamide-imide precursor (polyamide-polyamic acid).

Examples of organic polar solvents that can be used include formamide solvents (e.g., sulfoxide solvents such as dimethyl sulfoxide and diethyl sulfoxide, N,N-dimethylformamide, and N,N-diethylformamide), acetamide solvents (e.g., N,N-dimethylacetamide and N,N-diethylacetamide), pyrrolidone solvents (e.g., N-methyl-2-pyrrolidone and N-vinyl-2-pyrrolidone), phenol solvents (e.g., phenol, o-, m-, or p-cresol, xylenol, halogenated phenol, and catechol), ether solvents (e.g., tetrahydrofuran, dioxane, and dioxolan), alcohol solvents (e.g., methanol, ethanol, and butanol), cellosolve solvents (e.g., butyl cellosolve), hexamethylphosphoramide, and γ-butyrolactone. It is desirable that these solvents be used alone or as a mixed solvent. Solvents that are particularly preferably used are N,N-dimethylacetamide and N-methyl-2-pyrrolidone.

A dispersion of the conductive agent according to the present invention and known additives may be mixed with the polyamide-polyamic acid solution obtained as above, and thus a coating liquid may be prepared. The application of the coating liquid to a support (forming mold) followed by a treatment such as heating results in conversion of the polyamide-polyamic acid to a polyamide-imide.

Examples of the method for imidization include a method in which dehydration-ring closing is induced by heating treatment and a method in which ring closing is chemically induced with the aid of a dehydration-ring closing catalyst. When dehydration-ring closing is induced by heating treatment, for example, the reaction temperature is in the range of 300 to 400° C. and preferably in the range of 180 to 350° C., and the heating treatment time is in the range of 30 seconds to 10 hours and preferably in the range of 5 minutes to 5 hours. When a dehydration-ring closing catalyst is used, the reaction temperature is in the range of 0 to 180° C. and preferably in the range of 10 to 80° C., and the reaction time is in the range of several tens of minutes to several days and preferably in the range of 2 hours to 12 hours. Examples of the dehydration-ring closing catalyst include anhydrides of acetic acid, propionic acid, butyric acid, and benzoic acid.

(b) Isocyanate Method

In the isocyanate method, for example, a compound having a structure represented by the following formula (3) or (4) can be used as the tricarboxylic acid derivative having an acid anhydride group.

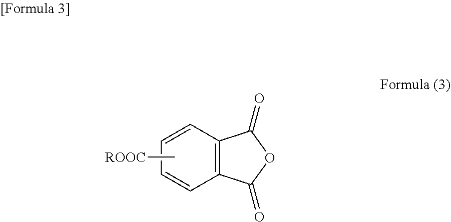

In this formula, R represents a hydrogen atom, an alkyl group having 1 to 10 carbon atoms, or a phenyl group.

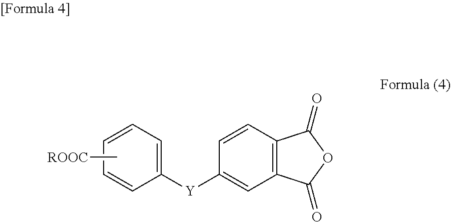

In this formula, R represents a hydrogen atom, an alkyl group having 1 to 10 carbon atoms, or a phenyl group, and Y represents —CH₂—, —CO—, —SO₂—, or —O—.

Any derivatives having a structure represented by either of the above formulae can be used, and a preferred example is trimellitic anhydride. These tricarboxylic acid derivatives having an acid anhydride group may be used alone or as a mixture depending on the intended purpose.

Examples of the aromatic polyisocyanate used as the other reactant in synthesis of a polyamide-imide according to the present invention include 4,4′-diphenylmethane diisocyanate, tolylene diisocyanate, xylylene diisocyanate, 4,4′-diphenyl ether diisocyanate, 4,4′-[2,2-bis(4-phenoxyphenyl)propane]diisocyanate, biphenyl-4,4′-diisocyanate, biphenyl-3,3′-diisocyanate, biphenyl-3,4′-diisocyanate, 3,3′-dimethylbiphenyl-4,4′-diisocyanate, 2,2′-dimethylbiphenyl-4,4′-diisocyanate, 3,3′-diethylbiphenyl-4,4′-diisocyanate, 2,2′-diethylbiphenyl-4,4′-diisocyanate, 3,3′-dimethoxybiphenyl-4,4′-diisocyanate, 2,2′-dimethoxybiphenyl-4,4′-diisocyanate, naphthalene-1,5-diisocyanate, and naphthalene-2,6-diisocyanate.

These aromatic polyisocyanates may be used alone or in combination. If necessary, any of aliphatic or alicyclic isocyanates and tri- or higher-functional polyisocyanates, such as hexamethylene diisocyanate, 2,2,4-trimethylhexamethylene diisocyanate, isophorone diisocyanate, 4,4′-dicyclohexylmethane diisocyanate, trans-cyclohexane-1,4-diisocyanate, hydrogenated m-xylylene diisocyanate, and lysine diisocyanate, can be used in addition to the above aromatic polyisocyanates.

The above tricarboxylic acid derivative having an acid anhydride group and the above aromatic polyisocyanate may be dissolved in an organic polar solvent to prepare a solution containing a polyamide-imide precursor, and a dispersion of the conductive agent according to the present invention and various known additives may be mixed with the obtained solution to prepare a coating liquid. The application of the coating liquid to a support is followed by heating treatment, causing conversion from the polyamide-imide precursor to the polyamide-imide. In the conversion to the polyamide-imide by this method, the polyamide-imide is produced substantially without formation of a polyamic acid as an intermediate (with generation of carbon dioxide gas). The following reaction formula (I) is an example of polyamide-imide formation using trimellitic anhydride and an aromatic isocyanate.

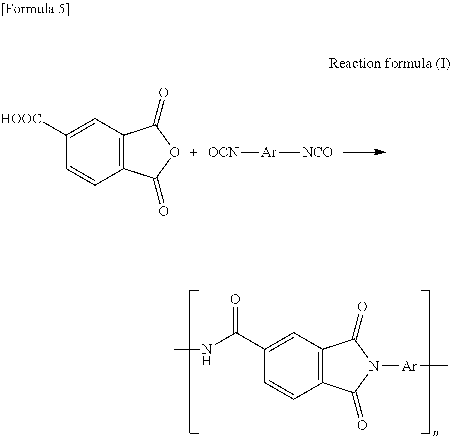

In this formula, Ar represents an aromatic group.

Further, when a polyamide-imide is used in the substrate, a dispersion of the conductive agent according to the present invention and various known additives can be mixed with a solution of the polyamide-imide to prepare a coating liquid, since polyamide-imides, unlike polyimides, are highly soluble in organic polar solvents. As the solvent, there can be used an organic polar solvent as mentioned above.

In addition to the polyamide-imide, polyimide, polycarbonate, polyphenylene sulfide, polyvinylidene fluoride, polyalkylene terephthalate (such as polyethylene terephthalate or polybutylene terephthalate), polyether, polyetherketone, polyetheretherketone, or ethylene-tetrafluoroethylene copolymer may be used in the substrate. In this case, it is preferable that the content of the polyamide-imide in the substrate be 51 mass % or more, more preferably 90 mass % or more, relative to the total amount of the resin. It is even more preferable that the entire substrate consist of the polyamide-imide.

[Dispersant]

The dispersant according to the present invention has a block polymer structure. Specifically, it is preferable that the dispersant have a block polymer structure containing a segment derived from a basic (meth)acrylate and a segment derived from a neutral (meth)acrylate. Thanks to such a block structure, the functions of the dispersant can be separately assigned to the different segments unlike the case where a polymer of the random copolymerization type is used as a dispersant.

(Segment Derived from Basic (Meth)Acrylate)

It is preferable that the dispersant having a block polymer structure according to the present invention contain a segment derived from a basic (meth)acrylate (this segment will be referred to as “segment A” hereinafter). Specifically, it is preferable that the dispersant be a block polymer derived from a (meth)acrylate having a basic group. Preferred as the basic group is an amino group or an alkyl-substituted amino group, and it is preferable that the segment A be a segment (monomer unit) represented by the following formula (5).

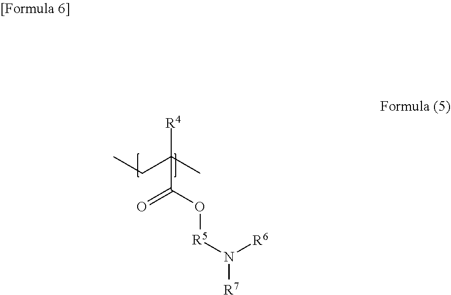

In this formula, R⁴ represents a hydrogen atom or a methyl group, R⁵ represents an alkylene group having 1 to 10 carbon atoms, and R⁶ and R⁷ each independently represent a hydrogen atom or an alkyl group having 1 to 10 carbon atoms.

Specific examples of the alkylene group having 1 to 10 carbon atoms which is represented by R⁵ include alkylene groups such as a methylene group, an ethylene group, a trimethylene group, a tetramethylene group, a pentamethylene group, a hexamethylene group, and a heptamethylene group. It is preferable that R⁵ be an alkylene group having 1 to 5 carbon atoms.

Specific examples of the alkyl group having 1 to 10 carbon atoms which is represented by R⁶ or R⁷ include linear or branched alkyl groups such as a methyl group, an ethyl group, an n-propyl group, an isopropyl group, an n-butyl group, an isobutyl group, a sec-butyl group, a tert-butyl group, a pentyl group, a hexyl group, a heptyl group, an octyl group, a nonyl group, and a decyl group. It is preferable that R⁶ and R⁷ be each independently a hydrogen atom or an alkyl group having 1 to 5 carbon atoms.

Examples of (meth)acrylates that can form such a segment include N,N-dimethylaminoethyl (meth)acrylate, dimethylaminoethyl (meth)acrylate, and t-butylaminoethyl (meth)acrylate.

A plurality of such (meth)acrylates may be used together.

In the dispersant according to the present invention, it is preferable that the content of the structural unit derived from a basic (meth)acrylate be in the range of 10 to 90 mass % relative to the total structural units of the polymer. It is more preferable that the content of the structural unit derived from a basic (meth)acrylate be 20 to 80 mass %.

(Segment Derived from Neutral (Meth)Acrylate)

It is preferable that the dispersant having a block polymer structure according to the present invention contain a segment derived from a neutral (meth)acrylate (this segment will be referred to as “segment B” hereinafter). Specifically, it is preferable that the dispersant be a block polymer derived from a (meth)acrylate having a neutral group. Examples of the neutral group include an alkyl group, an ether group, an oxycarbonyl group, and a hydroxy group. It is particularly preferable that the segment B be a segment (monomer unit) represented by the following formula (6).

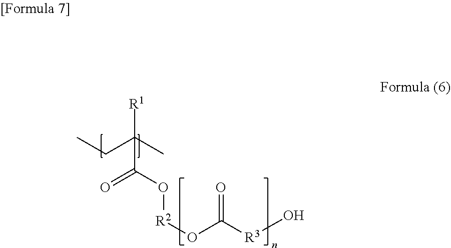

In this formula, n represents an integer of 1 to 10, R¹ represents a hydrogen atom or a methyl group, R² represents an alkylene group having 1 to 10 carbon atoms, and R³ represents an alkylene group having 1 to 10 carbon atoms.

In the formula (6), it is preferable that n be an integer of 1 to 7, and it is more preferable that n be an integer of 1 to 5.

Specific examples of the alkylene group having 1 to 10 carbon atoms which is represented by R² include a methylene group, an ethylene group, a trimethylene group, a tetramethylene group, a pentamethylene group, a hexamethylene group, and a heptamethylene group. It is preferable that R² be an alkylene group having 1 to 5 carbon atoms.

Specific examples of the alkylene group having 1 to 10 carbon atoms which is represented by R³ include a methylene group, an ethylene group, a trimethylene group, a tetramethylene group, a pentamethylene group, a hexamethylene group, and a heptamethylene group. It is preferable that R³ be an alkylene group having 1 to 8 carbon atoms, and it is more preferable R³ be an alkylene group having 3 to 8 carbon atoms.

The partial structure represented by the formula (6) in the segment B may consist of one type of monomer unit or may consist of a plurality of types of monomer units.

The partial structure (monomer unit) contained in the segment B may consist of the partial structure represented by the formula (6) or may include the partial structure represented by the formula (6) and another partial structure. When another partial structure is contained in the segment B, this other partial structure may be introduced by any mode of polymerization such as random copolymerization or block copolymerization.

It is preferable that the segment B contain 10 to 90 mass %, more preferably 20 to 80 mass %, of the partial structure represented by the formula (6). It is preferable that the segment B have no basic group-containing partial structure such as a partial structure represented by the formula (5) in the segment A. When the segment B has a basic group-containing partial structure, it is preferable that the proportion of the basic group-containing partial structure in the segment B be 1 mass % or less.

It is preferable that another partial structure that may be contained in the segment B be formed from a monomer copolymerizable with both the monomer for forming the partial structure represented by the formula (6) and the monomer for forming the segment A. Specific examples of the monomer that can form the other partial structure of the segment B include an aromatic unsaturated monomer (styrene monomer) and a (meth)acrylic acid ester. Examples of the aromatic unsaturated monomer include styrene and α-methylstyrene. Examples of the (meth)acrylic acid ester include methyl (meth)acrylate, ethyl (meth)acrylate, propyl (meth)acrylate, isopropyl (meth)acrylate, butyl (meth)acrylate, octyl (meth)acrylate, 2-ethylhexyl (meth)acrylate, glycidyl (meth)acrylate, benzyl (meth)acrylate, hydroxyethyl (meth)acrylate, polyethylene glycol (meth)acrylate, and polypropylene glycol (meth)acrylate.

It is preferable that the other partial structure that may be contained in the segment B be a partial structure (monomer unit) represented by the following formula (7).

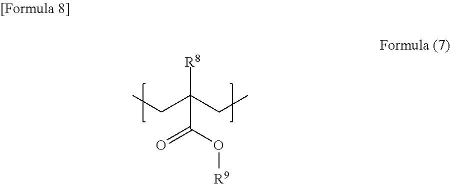

In this formula, R⁸ represents a hydrogen atom or a methyl group, and R⁹ represents an optionally-substituted alkyl group having 1 to 10 carbon atoms.

Specific examples of the alkyl group having 1 to 10 carbon atoms which is represented by R⁹ in the formula (7) include linear or branched alkyl groups such as a methyl group, an ethyl group, an n-propyl group, an isopropyl group, an n-butyl group, an isobutyl group, a sec-butyl group, a tert-butyl group, a pentyl group, a hexyl group, a heptyl group, an octyl group, a nonyl group, and a decyl group. It is preferable that R⁹ be an optionally-substituted alkyl group having 1 to 5 carbon atoms. When the alkyl group having 1 to 10 carbon atoms which is represented by R⁹ has a substituent, the substituent is, for example, an aryl group. The number of carbon atoms in the aryl group is typically 6 to 12 and preferably 6 to 9. Specific examples of the aryl group include a phenyl group, a tolyl group, a xylyl group, a mesityl group, and a naphthyl group. The position of the substituent is not particularly limited. The alkyl group typically has 1 to 4 substituents, and the number of the substituents is preferably 1 to 3 and more preferably 1.

The polymerization reaction is carried out by a known method.

(Block Polymer)

The dispersant according to the present invention has a block polymer structure. Specifically, it is referable that the dispersant have a block polymer structure containing at least a segment derived from a basic (meth)acrylate and a segment derived from a neutral (meth)acrylate. It is further preferable that the dispersant be a block copolymer having the segment A and the segment B.

The method of producing the block copolymer is not particularly limited. The block copolymer can be obtained by carrying out block polymerization based on, for example, a living radical polymerization method to allow the monomers to undergo polymerization reactions sequentially. In the polymerization reactions of the monomers, a block A consisting of the segment A may be produced first, and then the monomer for forming a block B consisting of the segment B may be polymerized to the block A, or, the block B may be produced first and then the monomer for forming the block A may be polymerized to the block B. In the production of the block copolymer, the block A and the block B may be separately produced through polymerization reactions of the monomers, and then the block A and the block B may be coupled together.

It is preferable that the block copolymer be a diblock copolymer consisting of the block A and the block B, and this diblock copolymer is typically formed by bonds such as (block A)-(block B) and (block B)-(block A). The living radical polymerization method is a polymerization method that allows precise control of the molecular structure while ensuring the simplicity and versatility of radical polymerization. The living radical polymerization method is classified into the following methods according to the technique used for stabilization of the polymer chain ends: methods using a transition metal catalyst (ATRP), methods using a sulfur-based reversible chain transfer agent (RAFT), and methods using an organic tellurium compound (TERP). Among these, methods described in International Patent Publications No. WO 2004/14848 and No. WO 2004/14962 which use an organic tellurium compound (TERP) are preferred from the viewpoint of the variety of usable monomers and the control of the molecular weight in the polymer domain.

It is preferable that the weight-average molecular weight Mw of the dispersant according to the present invention be in the range of 7000 to 20000. When the weight-average molecular weight Mw is 7000 or more, the thermal decomposition of the dispersant can be prevented during a baking step in which polyamide-imide formation is performed through dehydration-ring closing induced by heating treatment (300 to 400° C.), and this leads to prevention of aggregation of carbon black and hence to maintenance of uniformity in resistance. From the viewpoint of solubility in a conductive agent dispersion, it is preferable that the weight-average molecular weight Mw be 20000 or less.

The weight-average molecular weight Mw can be measured by gel permeation chromatography. Exemplary measurement conditions are as follows.

The weight-average molecular weight (Mw) and number-average molecular weight (Mn) can be measured by using a GPC (trade name: HPLC 11 Series, manufactured by Agilent Technologies), a column (trade name: Shodex GPC LF-804, manufactured by Showa Denko K.K.), and a mobile phase (10 mM LiBr/N-methylpyrrolidone solution) and referring to a calibration curve created using polystyrene (molecular weight: 1090000, 775000, 427000, 190000, 96400, 37900, 10200, 2630, 440, and 92) as a standard material.

[Conductive Agent]

A known electron-conductive or ion-conductive material can be used as the conductive agent dispersed in the substrate layer in the present invention.

Examples of the electron-conductive material include: carbon materials for rubber products, such as carbon black, SAF (super abrasion furnace black), ISAF (intermediate super abrasion furnace black), HAF (high abrasion furnace black), FEF (fast extrusion furnace black), GPF (general purpose furnace black), SRF (semi-reinforcing furnace black), FT (fine thermal black), and MT (medium thermal black); other carbon materials such as coloring (inking) carbon subjected to a treatment such as oxidation, pyrolytic carbon, natural graphite, artificial graphite, and carbon nanotube; metals and metal oxides, such as antimony-doped tin oxide, titanium oxide, zinc oxide, nickel, copper, silver, and germanium; and conductive polymers such as polyaniline, polypyrrole, and polyacetylene.

Examples of the ion-conductive material include: inorganic ion-conductive materials such as sodium perchlorate, lithium perchlorate, calcium perchlorate, and lithium chloride; organic ion-conductive materials such as perchloric acid salts, sulfuric acid salts, ethosulfate salts, methylsulfate salts, phosphoric acid salts, fluoroboric acid salts, and acetates of quaternary ammoniums, such as tridecylmethyldihydroxyethylammonium perchlorate, lauryltrimethylammonium perchlorate, modified aliphatic dimethylethylammonium ethosulfate, N,N-bis(2-hydroxyethyl)-N-(3′-dodecyloxy-2′-hydroxypropyl)methylammonium ethosulfate, 3-laurylamidopropyl-trimethylammonium methylsulfate, stearamidopropyldimethyl-β-hydroxyethyl-ammonium-dihydrogen phosphate, tetrabutylammonium fluoroborate, stearylammonium acetate, and laurylammonium acetate; and charge-transfer complexes.

In the present invention, it is preferable that the conductive agent be acidic. The use of a conductive agent which is acidic enables achieving of a high affinity for the dispersant according to the present invention and hence improved dispersion stability.

Being “acidic” means that when the conductive agent weighting 2 g is added to 20 mL of distilled water and stirred for 5 minutes, the pH value of the resulting aqueous dispersion at 23° C. is less than 7.0.

The conductive agent may be added in an amount such that the volume resistance value and surface resistance value of the intermediate transfer member fall within the desired ranges. Typically, it is preferable to add the conductive agent in an amount of 10 to 20 parts by mass relative to 100 parts by mass of the resin, and the amount of the conductive agent added is more preferably 10 to 16 parts by mass relative to 100 parts by mass of the resin.

Preferred examples of the conductive agent include acidic carbon black and acidic carbon nanotube.

The type of the carbon nanotube is not particularly limited, and single-walled carbon nanotube or multi-walled carbon nanotube can be used. Of these, multi-walled carbon nanotube is preferred from the viewpoint of electrical properties, mechanical properties, and affinity for thermoplastic resins. It is preferable that the number of walls of the multi-walled carbon nanotube be 20 to 50. When the number of walls of the multi-walled carbon nanotube is within this range, the electrical conductivity and mechanical properties of the intermediate transfer belt can be further improved.

The diameter of the carbon nanotube is preferably 3 to 500 nm and more preferably 10 to 200 nm. The length of the carbon nanotube is preferably 0.1 to 50 μm and more preferably 0.5 to 20 μm.

The cylindrical graphite structure characteristic of carbon nanotube can be confirmed by means of a high-resolution transmission electron microscope. A graphite layer is preferred which is clearly seen as being straight when observed with a transmission electron microscope. It is acceptable that the graphite layer observed is distorted. A carbon nanomaterial with a distorted graphite layer may be classified as carbon nanofiber in other contexts; however, in the present invention, a carbon nanomaterial with a distorted graphite layer is included in the concept of carbon nanotube.

Acidic carbon black having a pH of 5.0 or less is preferably used as the conductive agent in the present invention, from the viewpoint of achieving good dispersibility and dispersion stability in a resin composition (resin component) to enable reduced variation in resistance of a semiconductive belt and achieving reduction in electric field dependence and prevention of transfer voltage-induced concentration of electric field to improve the temporal stability of electrical resistance.

The acidic carbon black having a pH of 5.0 or less can be produced by oxidizing carbon black to introduce, for example, carboxy, quinone, lactone, or hydroxy groups onto the surface of the carbon black. This oxidization can be carried out, for example, by an air oxidation method in which carbon black is brought into contact and reacted with air in a high-temperature atmosphere, a method in which carbon black is reacted with nitrogen oxide or ozone at ordinary temperature, or a method in which carbon black is oxidized with air at high temperature and then oxidized with ozone at low temperature. Specifically, the acidic carbon black having a pH of 5.0 or less can be produced by a contact process. Examples of this contact process include a channel process and a gas black process.

The acidic carbon black can be produced also by a furnace black process using gas or oil as a raw material. If necessary, after any of the above processes, the carbon black may be subjected to liquid-phase oxidation, for example, with nitric acid. The acidic carbon black, although producible by a contact process as described above, is generally produced by a closed furnace process. In general, this furnace process only yields carbon black with a high pH and a low volatile matter content; however, the pH can be adjusted by subjecting the carbon black to the liquid-phase oxidation mentioned above.

The pH value of the acidic carbon black in the present invention is preferably 5.0 or less, more preferably 4.5 or less, and even more preferably 4.0 or less. Thanks to the presence of oxygen-containing functional groups such as carboxy, hydroxy, quinone, or lactone groups on its surface, the acidic carbon black having a pH of 5.0 or less exhibits good dispersibility and dispersion stability in resins to enable reduced resistance variation of a semiconductive belt and also offers reduced electric field dependence and hence reduced likelihood of transfer voltage-induced concentration of electric field. The lower limit of the pH value of the acidic carbon black is about 2.0.

The content of volatile matter in the acidic carbon black having a pH of 5.0 or less is preferably in the range of 1 to 25 mass %, more preferably in the range of 3 to 20 mass %, and even more preferably in the range of 3.5 to 15 mass %. If the content of volatile matter is less than 1 mass %, the effect of the oxygen-containing functional groups attached on the surface of the carbon black may be lost, with the result that the dispersibility in the resin component may decrease. If the content of volatile matter is more than 25 mass %, the carbon black may be decomposed when dispersed in the resin composition, or the appearance of the surface of the belt according to the present invention may deteriorate because of, for example, an increase in the amount of a substance such as water adsorbed by the oxygen-containing functional groups on the surface of the carbon black.

When the content of volatile matter is in the range of 1 to 25 mass %, the dispersion in the resin composition can be improved. The content of volatile matter can be determined as the proportion of organic volatile matter (such as carboxy, hydroxy, quinone, or lactone groups) emitted when the carbon black is heated at 950° C. for 7 minutes.

Specific examples of the acidic carbon black having a pH of 5.0 or less include: “Printex 150T” (pH: 4.5, volatile matter content: 10.0 mass %), “Special Black 350” (pH: 3.5, volatile matter content: 2.2 mass %), “Special Black 100” (pH: 3.3, volatile matter content: 2.2 mass %), “Special Black 250” (pH: 3.1, volatile matter content: 2.0 mass %), “Special Black 5” (pH: 3.0, volatile matter content: 15.0 mass %), “Special Black 4” (pH: 3.0, volatile matter content: 14.0 mass %), “Special Black 4A” (pH: 3.0, volatile matter content: 14.0 mass %), “Special Black 550” (pH: 2.8, volatile matter content: 2.5 mass %), “Special Black 6” (pH: 2.5, volatile matter content: 18.0 mass %), “Color Black FW200” (pH: 2.5, volatile matter content: 20.0 mass %), “Color Black FW2” (pH: 2.5, volatile matter content: 16.5 mass %), and “Color Black FW2V” (pH: 2.5, volatile matter content: 16.5 mass %), all of which are manufactured by Degussa AG; and “MONARCH 1000” (pH: 2.5, volatile matter content: 9.5 mass %), “MONARCH 1300” (pH: 2.5, volatile matter content: 9.5 mass %), “MONARCH 1400” (pH: 2.5, volatile matter content: 9.0 mass %), “MOGUL-L” (pH: 2.5, volatile matter content: 5.0 mass %), and “REGAL400R” (pH: 4.0, volatile matter content: 3.5 mass %), all of which are manufactured by Cabot Corporation.

By virtue of the effect of the oxygen-containing functional groups which are present on its surface as described above, the acidic carbon black having a pH of 5.0 or less has better dispersibility in resin compositions than common carbon black, and it is therefore preferable to increase the amount of the acidic carbon black added as a fine conductive powder. In this case, the amount of conductive particles in the semiconductive belt is large, so that the effect of the use of the acidic carbon black, such as enabling reduction of in-plane variation of the electrical resistance value, can be maximized.

From the viewpoint of, for example, the dispersion stability of the conductive agent, it is preferable that the average particle size of the conductive agent be in the range of 0.05 to 0.20 μm. The average particle size of the conductive agent can be determined by taking an image of a cross-section of the intermediate transfer belt with an electron microscope and binarizing the image with an image processor.

<<Elastic Layer>>

The elastic layer is a layer which may be formed on the outer peripheral surface of the substrate if necessary and has a desired electrical conductivity and elasticity. It is preferable that the elastic layer be made of a rubber material. The thickness of the elastic layer can be, for example, 50 to 400 μm. Examples of the rubber material include resins having rubber elasticity, such as urethane rubber, chloroprene rubber (CR), and nitrile rubber (NBR). From the viewpoint of control of the electrical resistance of the intermediate transfer belt, it is preferable that the rubber material include chloroprene rubber or nitrile butadiene rubber.

The elastic layer can contain a known additive. For example, the elastic layer may contain a conductive agent in order to exhibit a desired electrical conductivity. As this conductive agent, there can be used a material for imparting electrical conductivity to the resin material of the intermediate transfer belt.

<<Surface Layer>>

The surface layer may be formed on the outer peripheral surface of the substrate or elastic layer if necessary. It is preferable that the surface layer be obtained by active energy radiation exposure and the resulting curing of an applied film of a surface layer-forming coating liquid containing an active energy radiation-curable composition containing fine metal oxide particles (A), a (meth)acrylate monomer (B) having a refractive index nD of 1.6 to 1.8, and a polyfunctional (meth)acrylate (C) other than the (meth)acrylate monomer (B). The surface layer can improve the durability of the intermediate transfer belt.

In the intermediate transfer belt of the present invention, it is preferable that the (meth)acrylate monomer (B) having a refractive index nD of 1.6 to 1.8 be at least one selected from compounds represented by the following formulae (a) to (g).

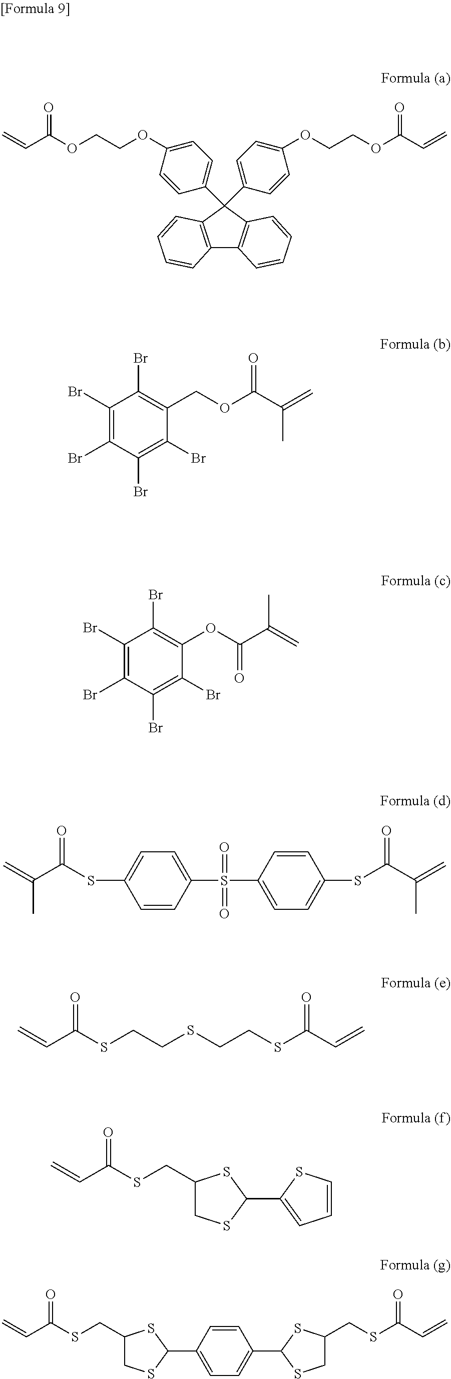

In the surface layer, it is preferable that the content of the fine metal oxide particles (A) be 5 to 30 mass %, the content of the structural unit derived from the (meth)acrylate monomer (B) having a refractive index nD of 1.6 to 1.8 be 20 to 50 mass %, and the content of the structural unit derived from the polyfunctional (meth)acrylate (C) other than the (meth)acrylate monomer (B) be 40 to 75 mass %, relative to the total amount of the fine metal oxide particles (A), the structural unit derived from the (meth)acrylate monomer (B), and the structural unit derived from the polyfunctional (meth)acrylate (C).

It is preferable that the fine metal oxide particles (A) consist of fine metal oxide particles subjected to surface treatment.

<<Method of Producing Intermediate Transfer Belt>>

The following will describe a production method for producing a seamless belt having an intermediate transfer belt as a substrate by using a coating liquid containing a carbon black dispersion containing the above-described polyamide-imide or its precursor and acidic carbon black.

Specifically, when a seamless belt is produced according to the present invention by using a coating liquid containing a carbon black dispersion, a polyamide-imide or its precursor, a solvent such as N-methylpyrrolidone, and optionally any additive(s), the production can be generally achieved through the following steps. That is, a seamless belt can be produced by the steps of: preparing a coating liquid; applying and spreading the coating liquid on a support (forming mold); removing the solvent from a film of the applied and spread liquid on the support by heating; promoting imidization of the precursor contained in the film by heating at elevated temperature (this step is also referred to as “baking step”); and removing the formed thin film from the support to obtain the thin film as a seamless belt.

First, an example where the support (forming mold) used is a centrifugal mold will be described. The following description is only illustrative, and the conditions are not limited to those described below.

It is preferable that the step of preparing a coating liquid be a step of first preparing a carbon black dispersion containing the above-described acidic carbon black dispersed by a dispersant having a block polymer structure containing a segment (A) derived from a basic (meth)acrylate and a segment (B) derived from a neutral (meth)acrylate and then mixing the carbon black dispersion and a polyamide-imide or its precursor.

A centrifugal mold preferably used in the step of applying and spreading the coating liquid on the support (forming mold) is one made up of a cylindrical rotation body, and the coating liquid is applied and spread (a film of the liquid is formed) uniformly over the entire inner surface of the cylindrical rotation body while the cylindrical rotation body is slowly rotated. After that, the rotation speed is increased up to a given speed, and the rotation is continued for a desired period of time during which the rotation speed is kept constant at the given speed.

Subsequently, while the rotation is continued, the temperature is slowly increased to evaporate the solvent in the film of the applied liquid at about 80 to 150° C. In this step of removing the solvent from the film of the applied and spread liquid on the support by heating, it is preferable that vapor in the atmosphere (e.g., evaporated solvent) be made to flow efficiently and removed. Once a self-supporting film is obtained, the temperature is decreased to ordinary temperature, and the obtained film is transferred to a heating oven (baking oven) capable of high temperature treatment.

This is followed by the step of promoting imidization of the precursor contained in the film by heating at elevated temperature, in which the film is subjected to high temperature treatment (baking) at about 300 to 400° C. to fully imidize the precursor.

After completion of the imidization, the thin film is slowly cooled and separated from the mold. In this manner, a seamless belt is formed. It is preferable that a mold release agent or layer be formed beforehand on the mold in order to facilitate the separation of the film.

<<Image-Forming Apparatus>>

Next, an image-forming method and an image-forming apparatus according to the present invention will be described.

It is preferable that the image-forming apparatus have an electrostatic latent image carrier (hereinafter also referred to as “photoconductor”) around which are arranged charging means, exposure means, development means using a developer containing a small-diameter toner, and transfer means that transfers a toner image formed by the development means to a transfer material via an intermediate transfer belt.

Specific examples of the image-forming apparatus include a copier and a laser printer, and particularly preferred is an image-forming apparatus capable of continuous printing of 5000 or more sheets. In such an apparatus, electric field is likely to be generated between the intermediate transfer belt and the transfer material because of a large amount of printing in a short time; however, the use of the intermediate transfer belt of the present invention reduces the generation of electric field, thus enabling stable secondary transfer.

An image-forming apparatus in which the intermediate transfer belt of the present invention can be used includes: a photoconductor on which an electrostatic latent image corresponding to image information is formed; a development device that develops the electrostatic latent image formed on the photoconductor; primary transfer means that transfers the toner image from the photoconductor onto the intermediate transfer belt; and secondary transfer means that transfer the toner image from the intermediate transfer belt to a transfer material such as a sheet of paper or an OHP sheet. This image-forming apparatus can, due to employing the intermediate transfer belt of the present invention, perform stable formation of toner images without occurrence of separation discharge during secondary transfer.

Examples of the image-forming apparatus in which the intermediate transfer belt of the present invention can be used include: a black-and-white image-forming apparatus that performs image formation with a monochromatic toner; a color image-forming apparatus that transfers different toner images sequentially from a photoconductor to an intermediate transfer belt; and a tandem color image-forming apparatus in which a plurality of photoconductors responsible for different colors are arranged in series on an intermediate transfer belt.

The intermediate transfer belt of the present invention is effective for use in a tandem color image-forming apparatus.

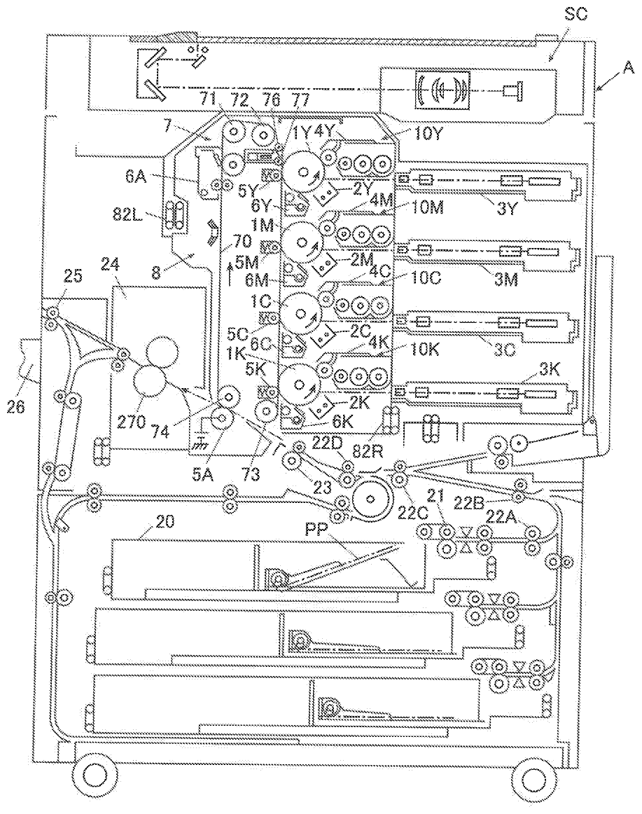

FIG. 1 is a cross-sectional configuration diagram showing an example of an image-forming apparatus in which the intermediate transfer belt of the present invention can be used.

In FIG. 1, the reference signs 1Y, 1M, 1C, and 1K denote photoconductors, the reference signs 4Y, 4M, 4C, and 4K denote development means, the reference signs 5Y, 5M, 5C, and 5K denote primary transfer rollers serving as primary transfer means, the reference sign 5A denotes a secondary transfer roller serving as secondary transfer means, the reference signs 6Y, 6M, 6C, and 6K denote cleaning means, the reference sign 7 denotes an endless belt-type intermediate transfer belt unit, the reference sign 24 denotes a hot roll-type fixation device, and the reference sign 70 denotes an intermediate transfer belt.

This image-forming apparatus is one called a tandem color image-forming apparatus and includes a plurality of image-forming sections 10Y, 10M, 10C, and 10K, an endless belt-type intermediate transfer belt unit 7 serving as a transfer section, an endless belt-type sheet-conveying means 21 that conveys a recording member P, and a hot roll-type fixation device 24 serving as fixation means. Above the main body A of the image-forming apparatus, there is provided an original image reading device SC.

The image-forming section 10Y, which forms an image of yellow color as one of toner images of different colors which are respectively formed on the photoconductors, includes: a drum-shaped photoconductor 1Y serving as a first photoconductor; and charging means 2Y, exposure means 3Y, development means 4Y, a primary transfer roller 5Y serving as primary transfer means, and cleaning means 6Y, which are arranged around the photoconductor 1Y. The image-forming section 10M, which forms an image of magenta color as another of the toner images of different colors, includes: a drum-shaped photoconductor 1M serving as a first photoconductor; and charging means 2M, exposure means 3M, development means 4M, a primary transfer roller 5M serving as primary transfer means, and cleaning means 6M, which are arranged around the photoconductor 1M. The image-forming section 10C, which forms an image of cyan color as still another of the toner images of different colors, includes: a drum-shaped photoconductor 1C serving as a first photoconductor: and charging means 2C, exposure means 3C, development means 4C, a primary transfer roller 5C serving as primary transfer means, and cleaning means 6C, which are arranged around the photoconductor 1C. The image-forming section 10K, which forms an image of black color as still another of the toner images of different colors, includes: a drum-shaped photoconductor 1K serving as a first photoconductor; and charging means 2K, exposure means 3K, development means 4K, a primary transfer roller 5K serving as primary transfer means, and cleaning means 6K, which are arranged around the photoconductor 1K.

The endless belt-type intermediate transfer belt unit 7 includes an endless belt-type intermediate transfer belt 70 serving as a second image carrier of the intermediate transfer endless belt type, the intermediate transfer belt 70 being wound around a plurality of rollers and rotatably supported.

The images of different colors formed by the image-forming sections 10Y, 10M, 10C, and 10K are sequentially transferred to the rotating endless belt-type intermediate transfer belt 70 by the primary transfer rollers 5Y, 5M, 5C, and 5K, and thus a composite color image is formed. The recording member P such as a sheet of paper, which is a transfer material stored in a sheet cassette 20, is fed by the sheet-conveying means 21 and conveyed, through a plurality of intermediate rollers 22A, 22B, 22C, and 22D and a resist roller 23, to the secondary transfer roller 5A serving as secondary transfer means, by which the color images are collectively transferred onto the recording member P. The recording member P with the transferred color images is subjected to fixation by the hot roll-type fixation device 24, then held by sheet discharge rollers 25 and discharged onto a copy receiving tray 26 placed on the exterior of the apparatus.

After transfer of the color images to the recording member P by the secondary transfer roller 5A and the subsequent self-stripping of the recording member P, the endless belt-type intermediate transfer belt 70 is cleaned by the cleaning means 6A to remove the remaining toner.

In the image-forming process, the primary transfer roller 5K is always brought into pressure contact with the photoconductor 1K. The other primary transfer rollers 5Y, 5M, and 5C are brought into pressure contact with the corresponding photoconductors 1Y, 1M, and 1C only during color image formation.

The secondary transfer roller 5A is brought into pressure contact with the endless belt-type intermediate transfer belt 70 only when the recording member P passes through the secondary transfer roller 5A in order to be subjected to secondary transfer.

Additionally, the enclosure 8 can be pulled out from the apparatus main body A via supporting rails 82L and 82R.

The enclosure 8 contains the image-forming sections 10Y, 10M, 10C, and 10K and the endless belt-type intermediate transfer belt unit 7.

The image-forming sections 10Y, 10M, 10C, and 10K are arranged in a line in the vertical direction. The endless belt-type intermediate transfer belt unit 7 is disposed to the left of the photoconductors 1Y, 1M, 1C, and 1K in the FIGURE. The endless belt-type intermediate transfer belt unit 7 is constituted of the endless belt-type intermediate transfer belt 70 wound around the rollers 71, 72, 73, 74, and 76 and being rotatable, the primary transfer rollers 5Y, 5M, 5C, and 5K, and the cleaning means 6A.

When the enclosure 8 is pulled out, the image-forming sections 10Y, 10M, 10C, and 10K and the endless belt-type intermediate transfer belt unit 7 are pulled out together from the main body A.

As described above, toner images are formed on the photoconductors 1Y, 1M, 1C, and 1K through charging, exposure, and development, the toner images of different colors are superimposed on the endless belt-type intermediate transfer belt 70 and collectively transferred to the recording member P, and are fixed by pressure and heat applied by the hot roll-type fixation device 24. After transfer of the toner images to the recording member P, the photoconductors 1Y, 1M, 1C, and 1K are cleaned by the cleaning means 6A to remove the toner left on the photoconductors during transfer, and then the cycle of charging, exposure, and development starts for the next image formation.

### Examples

Hereinafter, the present invention will be specifically described using Examples. The present invention is not limited to the Examples given below. The units “part(s)” and “%” as used in the following Examples mean “part(s) by mass” and “mass %”, unless otherwise stated.

<<Production of Intermediate Transfer Belt>>

[Production of Intermediate Transfer Belt 1]

<Preparation of Carbon Black Dispersion>

A given amount of dispersant 1 having a block polymer structure according to the present invention (TERPLUS D2015, manufactured by Otsuka Chemical Co., Ltd.) was dissolved in N-methylpyrrolidone (NMP) first, then acidic CB (acidic carbon black: Mitsubishi Carbon Black MA7, manufactured by Mitsubishi Chemical Corporation) was added, and the mixture was stirred. After that, the carbon black was dispersed with a ball mill to prepare a carbon black dispersion containing 8 parts by mass of dispersant 1 relative to 100 parts by mass of carbon black.

<Molding of Belt>

A polyamide-imide solution was prepared by mixing polyamide-imide varnishes, HR-11 INN (manufactured by Toyobo Co., Ltd., number-average molecular weight (Mn): 15000) and HR-16NN (manufactured by Toyobo Co., Ltd., number-average molecular weight (Mn): 30000), at a solid mass ratio of 50:50. To this solution was added a given amount of the carbon black dispersion prepared above, and the mixture was stirred and degassed to prepare a coating liquid. The coating liquid was applied to a mold and baked at 350° C. for 1 hour to obtain a 75-μm-thick intermediate transfer belt 1 containing 12 mass % of carbon black relative to the polyamide-imide as the matrix resin.

[Production of Intermediate Transfer Belts 2 to 8]

Intermediate transfer belts 2 to 8 containing 12 mass % of carbon black relative to the polyamide-imide as the matrix resin were produced in the same manner as the intermediate transfer belt 1 was produced, except that the type of the conductive agent, the type of the dispersant, and the amount (parts by mass) of the dispersant used per 100 parts by mass of carbon black were changed as shown in Table I.

The details of the materials listed in the table are as follows.

Acidic CB (Mitsubishi Carbon Black MA7 (pH: 3) manufactured by Mitsubishi Chemical Corporation)

Alkaline CB (Mitsubishi Carbon Black #45 (pH: 8) manufactured by Mitsubishi Chemical Corporation)

Dispersant 1: TERPLUS D2015 (block polymerization) manufactured by Otsuka Chemical Co., Ltd.

Dispersant 2: DISPARLON DN-900 (random polymerization) manufactured by Kusumoto Chemicals, Ltd.

Dispersant 3: FLOWLEN KDG-2400 (graft polymerization) manufactured by Kyoeisha Chemical Co., Ltd.

The values of the pH of the carbon blacks are those measured by the method previously described.

<<Evaluation of Intermediate Transfer Belts>>

Each intermediate transfer belt was mounted in an image-forming apparatus, “bizhub PRESS C11000” (manufactured by Konica Minolta, Inc.), and subjected to the following evaluation tests using sheets of embossed paper (LEATHAC, 302 g paper) as image supports.

(Evaluation of Halftone Image)

Images were printed on 1000000 sheets at a printing percentage of 20% and, after that, a black halftone image was output on 1000 sheets of embossed paper so that the image was formed over the entire surface of each sheet of the embossed paper. The resulting visible image was visually observed, and the quality of the black halftone image was evaluated according to the following evaluation criteria.

(Evaluation of Quality of Black Halftone Image Formed after Printing of 1000000 Sheets)

Excellent: Uneven transfer is not observed.

Good: Uneven transfer is observed, but there is no problem for practical use.

Poor: Uneven transfer is observed, and there is a problem for practical use.

(Folding Test Performed after Printing of 1000000 Sheets)

After the output of the black halftone image, the intermediate transfer belt was subjected to a folding test (MIT method) according to JIS P 8115. The number of double folds required for breakage was measured, and evaluation was made according to the following evaluation criteria. When the number of double folds required for breakage was less than 1000, the belt was determined to have a high risk of being broken during printing and was rated unacceptable.

Good: 1000 or more

Poor: Less than 1000

(Measurement of Dielectric Tangent)

For each of the intermediate transfer belts produced above, a 10-mm-diameter sample having both surfaces sputtered with silver was prepared. This sample was left in a room environment controlled to a temperature of 23° C. and a humidity of 50% for one day, after which the measurement was performed in the same environment. The value of the dielectric tangent was calculated from a capacitance value at 10 kHz using System 1296/1260 manufactured by Solartron Analytical.

TABLE I

| | Conductive agent | | Dispersant | | | Results | | | |
|---|---|---|---|---|---|---|---|---|---|
| | | Average | | | Amount | | Halftone image | Folding test | |
| Intermediate | | particle | | Type of | used | | formed after | performed after | |
| transfer belt | | size | | copolymer- | [parts by | Dielectric | printing of | printing of | |
| No. | Type | [μm] | Type | ization | mass] | tangent | 1000000 sheets | 1000000 sheets | Note |
| 1 | Acidic CB | 0.10 | Dispersant 1 | Block | 8 | 1.0 | Excellent | Good | Present invention |
| | | | | polymerization | | | | | |
| 2 | Acidic CB | 0.07 | Dispersant 1 | Block | 20 | 0.3 | Excellent | Good | Present invention |
| | | | | polymerization | | | | | |
| 3 | Acidic CB | 0.15 | Dispersant 1 | Block | 4 | 1.4 | Excellent | Good | Present invention |
| | | | | polymerization | | | | | |
| 4 | Acidic CB | 0.31 | Dispersant 1 | Block | 1 | 1.4 | Good | Good | Present invention |
| | | | | polymerization | | | | | |
| 5 | Acidic CB | 0.28 | Dispersant 1 | Block | 21 | 0.8 | Good | Good | Present invention |
| | | | | polymerization | | | | | |
| 6 | Alkaline CB | 0.18 | Dispersant 1 | Block | 8 | 1.4 | Good | Good | Present invention |
| | | | | polymerization | | | | | |
| 7 | Acidic CB | 0.18 | Dispersant 2 | Random | 10 | 3.3 | Poor | Poor | Comparative example |
| | | | | polymerization | | | | | |
| 8 | Acidic CB | 0.20 | Dispersant 3 | Graft | 8 | 3.7 | Poor | Poor | Comparative example |
| | | | | polymerization | | | | | |

Table I reveals that the use of the intermediate transfer belt of the present invention offers an intermediate transfer belt having superior durability.

Although embodiments of the present invention have been described and illustrated in detail, it is clearly understood that the same is by way of illustration and example only and not limitation, the scope of the present invention should be interpreted by terms of the appended claims.

The description, claims, drawings, and abstract of Japanese Patent Application No. 2018-107332, filed with Japan Patent Office on Jun. 5, 2018, are incorporated herein by reference in their entirety.

What is claimed is:

1. An intermediate transfer belt for use in an electrophotographic image-forming apparatus, the intermediate transfer belt comprising a polyamide-imide, a conductive agent, and a dispersant, the dispersant having a block polymer structure.

2. The intermediate transfer belt according to claim 1, wherein a dielectric tangent is in the range of 0.2 to 1.5 at 10 kHz in a 23° C. environment.

3. The intermediate transfer belt according to claim 1, wherein the dispersant has a block polymer structure containing a segment derived from a basic (meth)acrylate and a segment derived from a neutral (meth)acrylate.

4. The intermediate transfer belt according to claim 1, wherein the conductive agent is acidic.

5. The intermediate transfer belt according to claim 1, wherein the dispersant in the range of 1 to 20 parts by mass is comprised relative to 100 parts by mass of the conductive agent.

6. The intermediate transfer belt according to claim 1, wherein the conductive agent has an average particle size in the range of 0.05 to 0.20 μm.

7. An image-forming apparatus comprising the intermediate transfer belt according to claim 1.
